(19) United States
(12) Patent Application Publication
(10) Pub. No.: US 2018/0128900 A1
(43) Pub. Date: May 10, 2018

(54) METHOD AND SYSTEM FOR GENERATING AND DETECTING CENTIMETRE, MILLIMETRE OR SUB- MILLIMETRE ELECTROMAGNETIC WAVES AND ESPECIALLY TERAHERTZ ELECTROMAGNETIC WAVES

(71) Applicant: Richard AL HADI, Ramonville-Saint-Agne (FR)

(72) Inventor: Richard AL HADI, Ramonville-Saint-Agne (FR)

(21) Appl. No.: 15/575,893

(22) PCT Filed: May 20, 2016
(86) PCT No.: PCT/EP2016/061399

§ 371 Date: Nov. 21, 2017

(30) Foreign Application Priority Data
May 21, 2015 (FR) 1554580

(51) Int. Cl. G01S 7/03; G01S 7/491; G01S 17/89; G01S 7/481; G01S 13/90

(52) U.S. Cl. CPC G01S 7/03; G01S 7/4911; G01S 17/89; G01S 2013/9064; G01S 7/481; G01S 13/9035; G01S 7/4913

(57) ABSTRACT

A method for generating and detecting centimeter, submillimeter or millimeter electromagnetic waves, including the use of a single electronic device as generation source and as detector of the waves emitted from the source. A system for generating and detecting centimeter, submillimeter or millimeter electromagnetic waves, including an electronic device (1, 3) forming both a generation source and the detector of the waves emitted from the source. In one aspect, the electromagnetic waves are terahertz electromagnetic waves.

### TECHNICAL FIELD

The present invention relates to a method and a system for generating and detecting centimeter, millimeter or submillimeter electromagnetic waves, preferably in the terahertz domain.

The terahertz domain refers to electromagnetic waves the frequency of which ranges from 100 GHz (gigahertz) to 30 THz (terahertz), for millimeter or submillimeter wavelengths, typically of between 30 vim and 3 mm.

The invention generally aims to make systems for generating and detecting terahertz waves simpler, more compact and less expensive.

### PRIOR ART

Centimeter, millimeter and submillimeter waves are able to be generated and detected by numerous devices that are able to be classified into three categories according to their features and parameters: devices that are referred to hereinafter as thermal devices, optical devices and, finally, electronic devices.

With regard to thermal devices, heat sources are natural generators of millimeter and submillimeter waves. The black body is a wide-spectrum radiation source. Filters may be employed to filter out millimeter and submillimeter waves.

Among the thermal detectors that convert millimeter and submillimeter waves into thermal energy, mention may be made of bolometers, what are termed pyroelectric devices, i.e. made of a material in which a temperature change gives rise to a variation in electrical bias, and Golay cells, which are a type of opto-acoustic detector used mainly in infrared spectroscopy. Thermal detectors are thus used in order to detect temperature variations, and some of them to passively detect millimeter and submillimeter waves emitted by the environment. They are thus sensitive to infrared waves, and require the use of filters. In addition, temperature variations are subject to laws of thermal dissipation, which make the response time of these thermal detectors long: [1].

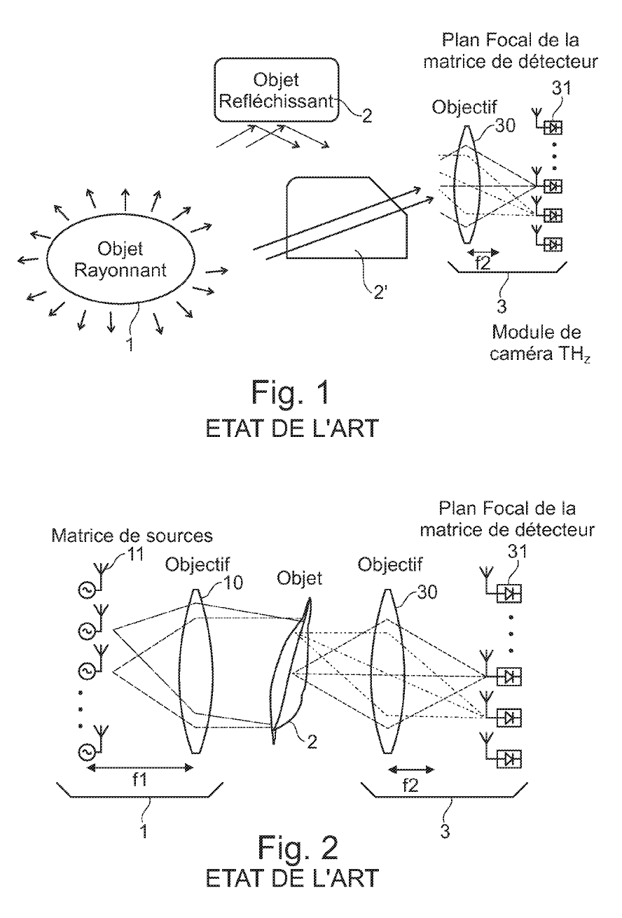

FIG. 1 schematically shows a thermal system in which the THz emission source 1 is the natural environment, and the THz waves re-emitted by an object 2 through reflection or by an object 2′ through transmission are able to be detected by a thermal detector such as a bolometer 3. In the example illustrated, the bolometer may be integrated in the form of a camera module, which comprises a lens 30 and a focal plane array 31 comprising a plurality of radiation detectors.

There are two types of optical source of millimeter and submillimeter waves: those emitting continuous waves (CW) and those emitting pulsed waves. Among the CW sources, mention may be made of low-pressure gas sources that are excited by CO₂ lasers or photomixers that are also used as CW detectors.

Quantum cascade lasers (abbreviated QCL) may operate both in CW mode and in pulsed mode. Time-domain spectrometers (abbreviated TDS, time domain spectroscopy) are pulsed generators that are used as wideband sources.

Publication [3] describes a quantum cascade laser the source and the detector of which are combined within one device. There are numerous drawbacks to the device disclosed, among which mention may be made of:
the need to perform cryogenic cooling for operation,
high DC power dissipation,
production using thin-layer technology that is difficult to implement,
a highly irregular output signal. Specifically, on account of the dispersion of waves in a quantum cascade laser, the beam is not controlled, thereby resulting in an irregularity.

With regard finally to electronic devices, there are a variety of electronic sources, such as backward wave oscillators (abbreviated BWO) and gyrotrons, such as described in publication [3], which require a strong magnetic field to operate.

However, the market is currently dominated by multiplexed sources based on Gunn diodes or tunnel diodes. These sources are relatively compact in comparison with BWOs and gyrotrons, are manufactured using diode technology, and use, by contrast, waveguide technologies that may be difficult to integrate.

In recent years, particular interest has been paid to silicon integrated technology in the field of millimeter and submillimeter waves. Silicon technology is available, robust and inexpensive.

The first patents relating to devices for detecting millimeter and submillimeter waves using silicon technology, among which mention may be made of U.S. Pat. No. 8,330,111B2, relate to direct power detectors. The operation of these detectors consists in using the signal rectification properties of transistors beyond cutoff frequencies (fT/fmax). These detectors are integrated with an antenna and a read circuit.

Patent application US 2014/0091376 discloses an optimization for this type of detector.

U.S. Pat. No. 8,907,284B2 discloses an integration of this type of detector in the form of a camera.

Heterodyne detectors are, for their part, more sensitive than direct power detectors. The operation of heterodyne detectors consists in transposing energy from a portion of the spectrum to a lower frequency (termed “intermediate” frequency) before detecting it. Thus, a heterodyne detector comprises a mixer and a local oscillator that acts as a reference for reference millimeter or submillimeter waves. When an external source excites the input of the mixer, usually denoted RF for radiofrequency signal, an intermediate frequency, usually denoted IF, is collected at the output. Such an operation is described in patent application US 2014/070893, for example.

In addition, heterodyne devices require a millimeter or submillimeter wave source to operate. The limit to producing millimeter or submillimeter wave sources using silicon technology is the cutoff frequency of the components (fT/fmax).

Harmonic systems are then implemented, these being able to be of the type with a free oscillator, such as described in publications [4, 5], of the type with a locked oscillator, such as described in publication jot or with a multiplication chain, such as described in publication [7].

FIG. 2 schematically shows the principle of operation of a THz electronic device with harmonics according to publication [5]: it involves illuminating an object 2, in an unfocussed manner, using a THz emission source 1 for active imaging in transmission mode. The source array 11 thus emits millimeter and submillimeter waves that the lens 10 transmits to the illuminated object 2. The millimeter and submillimeter waves re-emitted by the object 2 are received by the lens 30 of the detector (lens) 3, and then detected by the focal plane array 31. In other words, in this case, the source array 11, which is able to be programmed, provides background illumination to the focal plane array 31. According to the authors of this publication [5], this has the advantage of enabling a video camera, of CMOS type, to acquire images in real time, without the need to scan or steer the beam.

There are many drawbacks to all of the existing devices for generating and detecting millimeter and submillimeter waves.

First of all, the performance of detection devices produced using silicon technology has up until now been limited. It is therefore mandatorily necessary to associate them with emission devices.

In the case where a coherent detection device is necessary, it is also difficult to get the same wave reference to the detector as to the source.

In addition, regardless of the type of existing detectors, they do not enable phase or frequency changes of the detected THz sources to be extracted.

Finally, regardless of the type of existing generators and detectors, all of the systems that have been implemented up until now have been envisioned only with two separate devices, namely one for the emission and another for the detection. Now, implementing two separate devices involves a difficulty with regard to focussing, a high cost and, ultimately, a complex system.

There is therefore a need to improve systems for generating and detecting millimeter and submillimeter (THz) waves, in particular in order to enable coherent detection with the same wave reference as the source, to enable the extraction, by the detector, of phase or frequency changes of the sources, and to simplify the implementation thereof and to reduce the cost thereof.

The aim of the invention is to meet is need at least in part.

### DISCLOSURE OF THE INVENTION

To this end, one subject of the invention, according to one aspect, is a method for generating and detecting centimeter, submillimeter or millimeter electromagnetic waves, preferably terahertz electromagnetic waves, wherein a single electronic device is used as generation source and as detector of the waves emitted from the source.

Another subject of the invention is a system for generating and detecting centimeter, submillimeter or millimeter electromagnetic waves, preferably terahertz electromagnetic waves, comprising a single electronic device forming both a generation source and the detector of the waves emitted from the source.

“Electronic device” is understood to mean a device the components of which are produced using 3D component integration technology. There are numerous integration technologies. One example is CMOS (acronym for Complementary Metal Oxide Semiconductor) technology, but the invention is not restricted to this technology, and may be applied to any electronic component. Another example of integration is III-V diode technology or even very-large-scale integration (VLSI) technology or even hetero-junction bipolar transistor (HBT) integration technology.

Surprisingly, the inventor thought to carry out the generation and the detection of centimeter, millimeter or submillimeter waves using the same electronic device.

The inventor therefore overcame a general preconception in the field of THz waves according to which, in terms of system design, it was imperative to design an emission source independently of the detector.

In other words, all THz system designers thought up until now that such systems were able to be implemented only with two separate devices, namely an emission source and a detector.

There are many advantages to the invention, among which the following may be listed.

The main advantage of a system according to the invention is the ease of implementation, in particular with a simplified optical assembly, and the compactness and the cost, which are necessarily reduced in relation to the THz systems from the prior art.

Moreover, the invention avoids having to focus two separate wave processing chains, or having to use a diplexer, i.e. a passive telecommunications device for THz frequencies having two channels, each with frequency filtering, without bandwidth overlap, and having three ports, one of these being common to the two channels and the other two being isolated from one another and respectively terminating each of the channels.

The system according to the invention is able to operate at ambient temperature, and is able to be integrated into a multi-pixel configuration of camera type.

The emission and the detection of one and the same wave according to the invention makes it possible to envision coherent detection, with the possibility of detecting the amplitude of the wave, but also its phase. If a variable frequency source is used, then it may be employed to detect distance (radar), but also to extract the dielectric properties of various materials.

“Coherent THz radiation” is understood to mean, here and in the context of the invention, either monochromatic radiation with high spectral purity or a THz pulse the various spectral components of which have a well-determined phase relationship that conditions the temporal shape of the pulse.

Finally, a system according to the invention may have an array size that is able to be modulated on emission and on detection. This enables an integration of imager type.

According to a first advantageous embodiment, the system may comprise at least one adjustable-frequency AC power source equipped with an antenna.

Provision may be made for two adjustable-frequency AC power sources with current mirrors.

According to this first mode, it is possible to envision various advantageous variants with the choice of:
a bias tee linked between the antenna and a low-impedance current amplifier that is itself linked to a voltage source, the output of the amplifier defining the detection output of the device,
a bias tee linked between the antenna and a high-impedance current amplifier that is itself linked to a current source, the output of the amplifier defining the detection output of the device,
a grounded differential antenna linked to a low-impedance current amplifier that is itself linked to a voltage source, the output of the amplifier defining the detection output of the device. The advantage of this variant is the absence of a bias tee,
a grounded differential antenna linked to a high-impedance current amplifier that is itself linked to a current source, the output of the amplifier defining the detection output of the device.

The advantage of the systems according to the first mode is the integration in a circuit with an interface having analog and digital blocks for processing the signal.

According to a second embodiment, the system may comprise at least one frequency source equipped with an antenna. According to this second mode, it is possible to provide two differential frequency sources of “N-push” type that are equipped with a differential antenna. The invention is not limited to this type of source. Other oscillators may be used, such as for example linear oscillators such as those termed Armstrong oscillators, Hartley oscillators, Colpitts oscillators, Clapp oscillators, Pierce oscillators, phase shift oscillators, Wien bridge oscillators, cross-coupled LC oscillators, Robinson oscillators or non-linear oscillators or relaxation oscillators, such as a multivibrator, neon lamp oscillator, ring oscillator, what is termed a Royer oscillator or else what is termed a delay line oscillator.

The system according to the invention may comprise one or more frequency multiplication chains with a buffer circuit.

The system may advantageously comprise one or more antennae with a beam that is able to be steered by an electrical control circuit. It is thus possible to create images in real time by combining the orientation, as desired, of the beam emitted/received by the antenna with generation and detection from one and the same device.

The invention also relates to the use of the method or of a system as claimed in one of the previously described claims for imaging, in particular near-field imaging.

### DETAILED DESCRIPTION

Other advantages and features of the invention will become more apparent upon reading the detailed description of exemplary implementations of the invention, given by way of non-limiting illustration with reference to the following figures, among which:

FIG. 1 is a schematic view of a system for generating and detecting millimeter and submillimeter waves according to the prior art, with the environment as emission source,

FIG. 2 is a schematic view of another system for generating and detecting millimeter and submillimeter waves according to the prior art, with unfocussed illumination on an object,

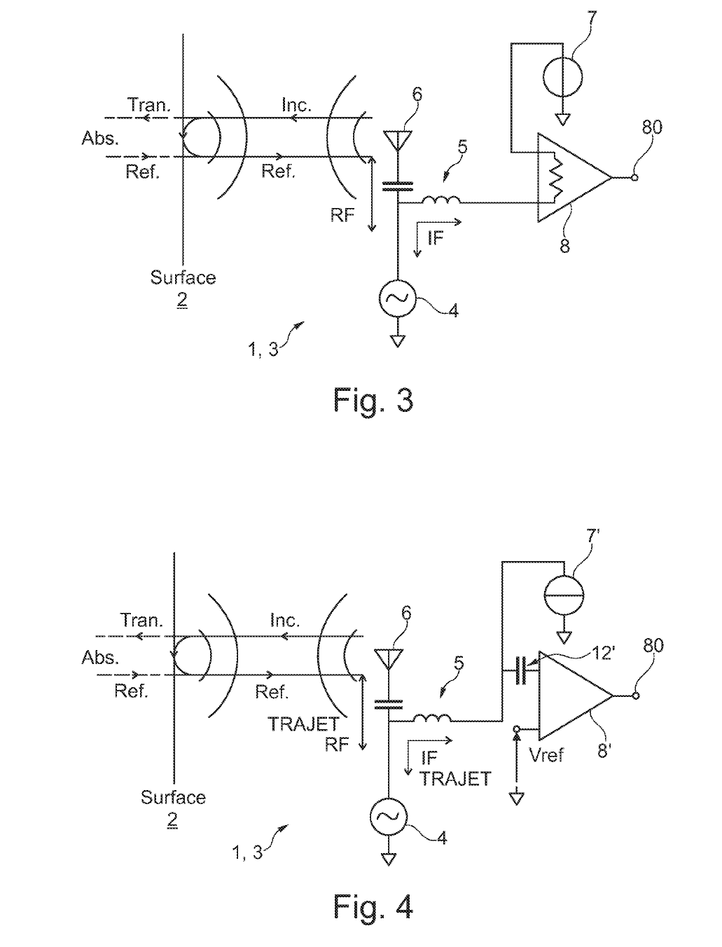

FIG. 3 is a schematic view of a first system for generating and detecting centimeter, millimeter and submillimeter waves according to the invention,

FIG. 4 is a schematic view of a second system for generating and detecting centimeter, millimeter and submillimeter waves according to the invention,

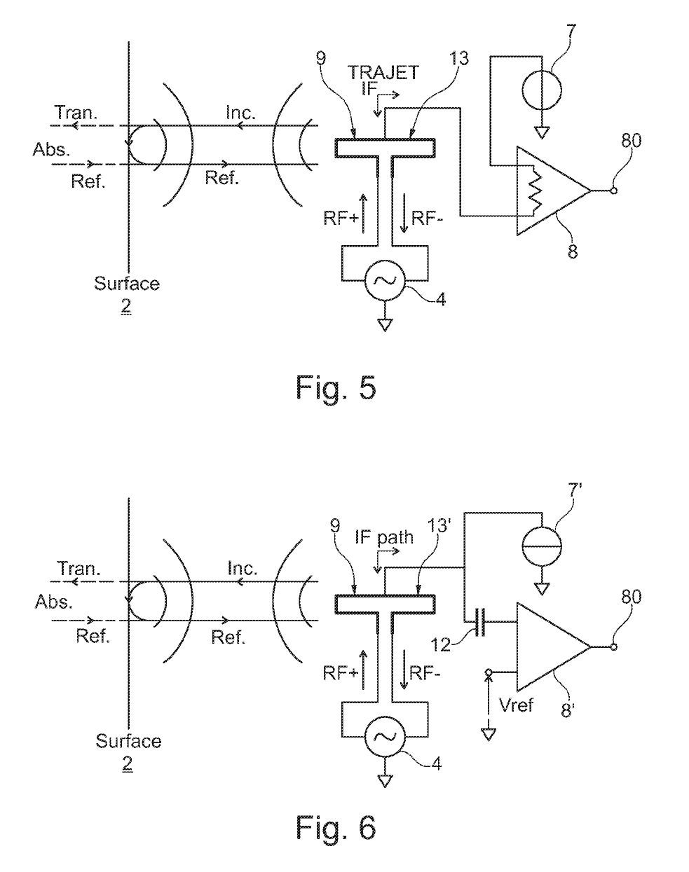

FIG. 5 is a schematic view of a third system for generating and detecting centimeter, millimeter and submillimeter waves according to the invention,

FIG. 6 is a schematic view of a fourth system for generating and detecting centimeter, millimeter and submillimeter waves according to the invention,

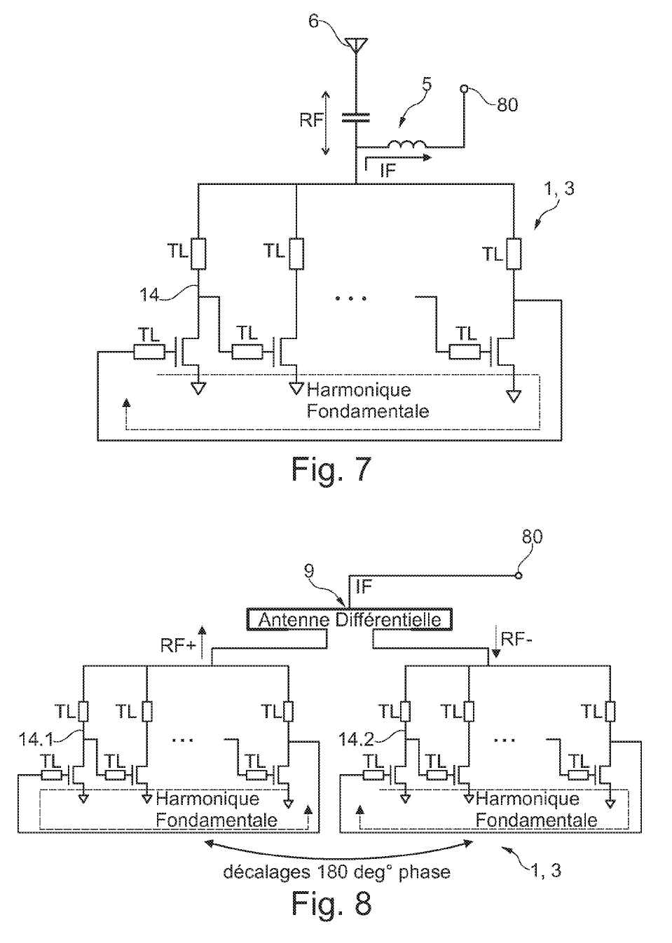

FIGS. 7 and 8 are schematic views of variants of a system for generating and detecting centimeter, millimeter and submillimeter waves according to the invention, in which the single device is a harmonic oscillator with an antenna and a differential antenna, respectively,

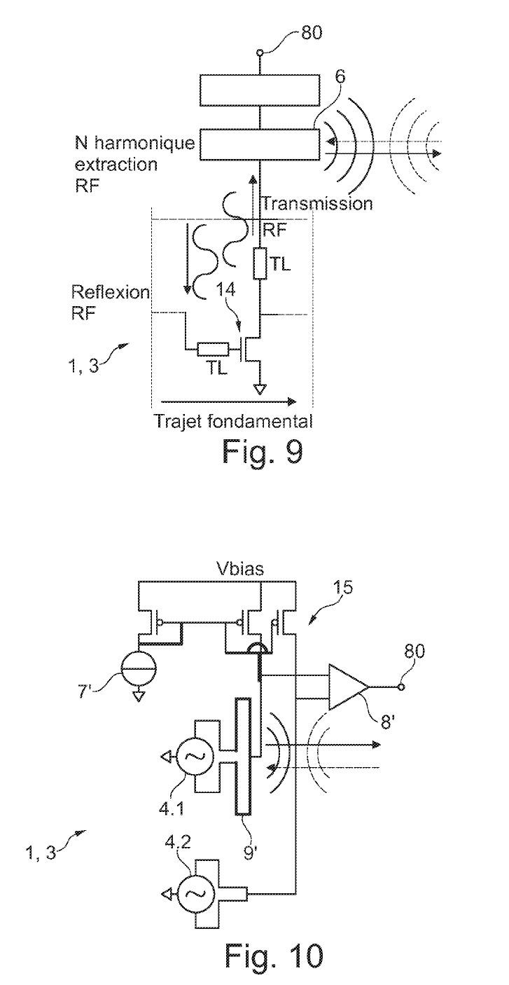

FIG. 9 is a schematic view of a system for generating and detecting centimeter, millimeter and submillimeter waves according to the invention, with a harmonic oscillator enabling the possible detection of phase and amplitude variations of the waves,

FIG. 10 is a schematic view of a variant of a system for generating and detecting millimeter and submillimeter waves according to the invention, with an improved read circuit,

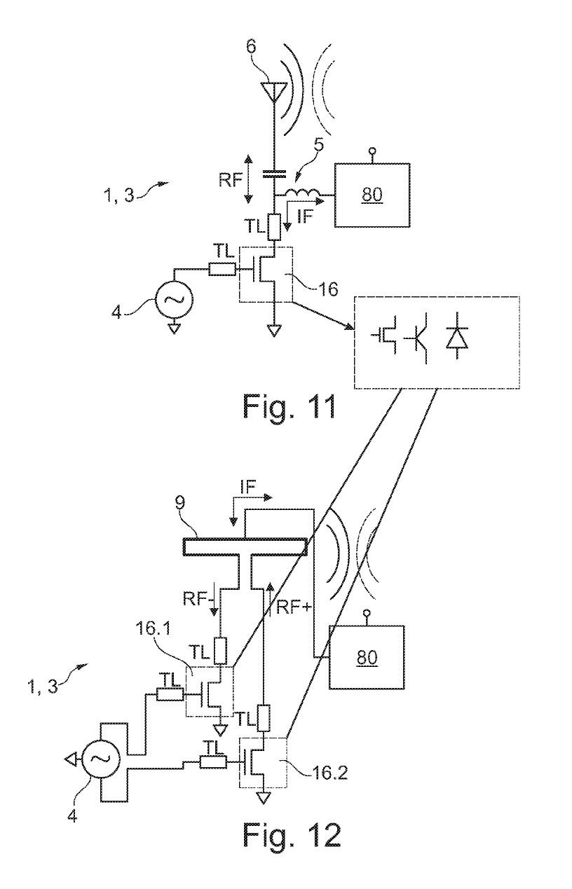

FIGS. 11 and 12 are schematic views of variants of a system for generating and detecting centimeter, millimeter and submillimeter waves according to the invention, in which the single device has a buffer circuit with an antenna and a differential antenna, respectively,

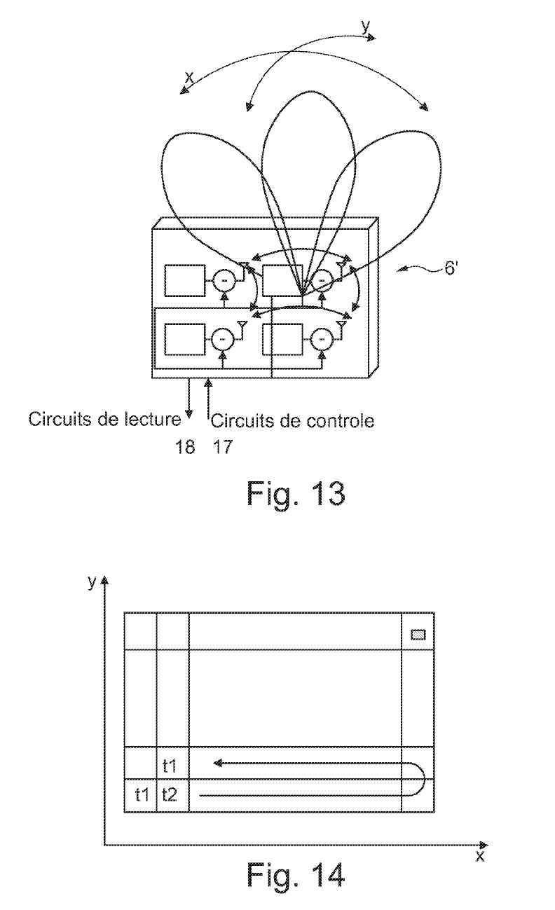

FIG. 13 is a schematic view of a variant of a system for generating and detecting centimeter, millimeter and submillimeter waves according to the invention, using an assembly of antennae with a beam that is able to be steered by an electrical control circuit,

FIG. 14 schematically shows the reconstruction of an image from a steerable beam emitted and received from the assembly of FIG. 13,

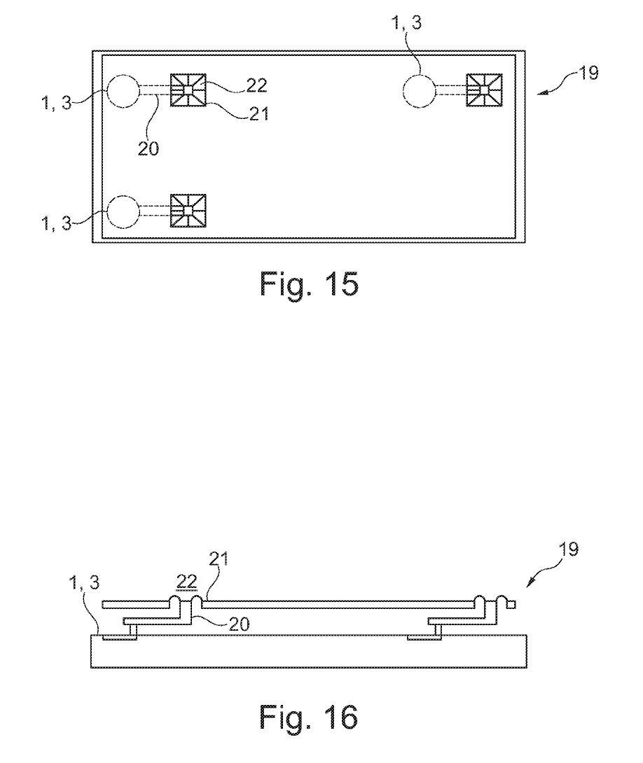

FIGS. 15 and 16 are plan and side views, respectively, of a system for near-field imaging without a coupler and incorporating a single emission/reception device according to the invention.

FIGS. 1 and 2, relating to the prior art, have already been described in detail in the preamble. They are not commented on hereinafter.

In all of the examples illustrated, the same elements are denoted by the same reference numerals.

All of the systems for generating and detecting centimeter, millimeter or submillimeter (THz) waves according to the invention comprise a single device 1, 3 forming both a source of emission of these waves and the detector of the waves emitted by the source.

In the single device, a read circuit at the frequency IF is used to detect current or voltage variations in the power supply circuit, for example.

As illustrated in FIGS. 3 to 6, the single device 1, 3 according to the invention makes it possible to emit THz waves that, at the surface of an object 2 positioned at a certain distance, are re-emitted, either by being reflected directly or by being absorbed and then reflected, the waves thus re-emitted being detected by the same electronic device. Any metal or dielectric material of the object 2 is able to reflect the THz waves with or without absorption.

In other words, the source itself is also used as detector of the generated wave that has been reflected. The electronic device 1, 3 according to the invention is then able to detect not only the amplitude of the wave (power), but also its phase.

The read circuit is employed in order to detect the current variations (FIGS. 3 and 5) or voltage variations (FIGS. 4 and 6).

As illustrated in FIG. 1, the single electronic device 1, 3 comprises an adjustable-frequency AC power source 4 linked to an antenna 6. A bias tee 5 is linked between the antenna 6 and a low-impedance current amplifier 8 that is itself linked to a voltage source 7. The output 80 of the amplifier 8 defines the detection output of the device.

Instead of the low-impedance current amplifier 8 and the voltage source 7, it is possible to provide a high-impedance current amplifier 8′ and a current source 7′ (FIG. 4). A DC rectifier block 12 may be provided at the input of the amplifier 8′ (FIG. 4).

Instead of the bias tee 5 and the simple antenna 6, it is possible to provide a differential antenna 9 with grounding 13 (FIGS. 5 and 6).

The source may be a harmonic oscillator 14 equipped with an antenna 6 (FIG. 7). This antenna 6 may be integrated or a discrete component, of patch type, or that has radiation properties through the substrate, or that implements a lens.

The harmonic oscillator may consist of differential oscillators 14.1, 14.2 of “N-push” type that are equipped with a differential antenna 9 (FIG. 8). As illustrated in FIG. 8, the two oscillators 14.1, 14.2 make it possible to obtain a phase shift of 180°.

At the interface between generator and detector, there is a transmission and reflection function. The waves emitted by the source 1 and then reflected are then retransmitted in the transistor. The transistor is either a fundamental mode generator or a detector of the nth harmonic reflected at the interface between the common node and the antenna 6 or 9, for example. As the antenna is a reciprocal device, i.e. one that emits and receives the waves in the same manner, it is thus possible to detect amplitude and phase variations of the reflected waves, as illustrated in FIG. 9.

Other variants and improvements may be provided without thereby departing from the scope of the invention.

One improvement that is envisioned may be made with regard to the read circuit. Current sources 4.1, 4.2 with current mirrors 15 may thus be incorporated, a reference pixel (blind pixel) may be used in order to reduce the shifts and amplify the voltage of the detector more effectively (FIG. 10).

It is also possible to envision that a digital CDS (acronym for correlated double sampling) system may also be implemented for the read circuit.

One of the variants of the invention may consist in using fundamental oscillators, or frequency multiplication chains with a buffer circuit. The buffer circuit 16, 16.1, 16.2 may be used as a detection circuit (FIGS. 11 and 12).

FIG. 13 illustrates an advantageous variant in which the device according to the invention comprises an assembly of antennae 6′ with an electromagnetic beam that is able to be steered by a suitable electrical control circuit P. It is possible to provide a single antenna 6′ with a beam with variable orientation.

This variant is advantageous because it is possible to create images in real time by combining the orientation, as desired, of the beam emitted/received by the antenna with generation and detection from one and the same device.

Moreover, it is possible to modulate the frequency of one or more antennae 6′ with a steerable beam.

FIG. 14 schematically shows the reconstruction of an image that it is possible to obtain in the read circuit 18 from a beam with variable orientation that is emitted/received by the assembly of antennae 6′.

High-quality images created in this way, having a very high number of pixels, are able to be obtained. In other words, with such a device, it is possible to obtain large image sizes with, by contrast, a small emitter/receiver size.

It is possible to envision numerous applications for the invention, among which mention may be made of interferometry, speed and vibration measurements, the extraction of complex dielectric properties of materials, frequency modulated continuous wave (abbreviated FMCW) radar, synthetic aperture radar (abbreviated SAR) and inverse synthetic aperture radar (abbreviated ISAR), near-field imaging, quality control, security control.

One particularly beneficial application is imaging, in particular dental imaging, in particular for children's teeth, in which the compactness of the system according to the invention enables it to be inserted into a child's mouth and to both emit and detect THz waves.

FIGS. 15 and 16 illustrate a single device 1, 3 according to the invention that is advantageously used in near-field imaging.

The imaging system 19, which incorporates a single device 1, 3 without an antenna, enables coherent near-field detection without the use of a coupler or a detector, such as are used in prior art systems in which a detector and a coupler are necessary for the near-field operation of the system. The invention described in the present application makes it possible to dispense with these components, greatly simplifying near-field imaging.

Now, dispensing with a coupler is a significant advantage. Specifically, a coupler is inherently a device that is able to operate only over a small frequency bandwidth.

Thus, by virtue of the device according to the invention, it is possible to obtain coherent near-field detection over a large frequency bandwidth.

The single device 1, 3 of the imaging system uses the reciprocity of the transmission lines 20 from and to the sensitive zone 21 of the evanescent wave fields 22.

The device 1, 3 used in a near-field system is able to integrated both in pixels and in multi-pixels so as to create a device of imager type.

### REFERENCES CITED

[1]: J. Gao, J. Hovenier, Z. Yang, J. Baselmans, A. Baryshev, M. Hajenius, T. Klapwijk, A. Adam, T. Klaassen, B. Williams et al., “Terahertz heterodyne receiver based on a quantum cascade laser and a superconducting bolometer,” Applied Physics Letters, vol. 86, no. 24, p. 244104, 2005.
[2]: P. Dean, Y. Leng Lim, A. Valavanis, R. Kliese, M. Nikolić, S. P. Khanna, M. Lachab, D. Indjin, Z. Ikonić, P. Harrison et al., “Terahertz imaging through self-mixing in a quantum cascade laser,” Optics letters, vol. 36, no. 13, pp. 2587-2589, 2011.
[3]: G. Gallerano, S. Biedron et al., “Overview of terahertz radiation sources,” in Proceedings of the 2004 FEL Conference, 2004, pp. 216-221.
[4]: Y. Zhao, J. Grzyb, and U. Pfeiffer, “A 288-ghz lens-integrated balanced triple-push source in a 65-nm cmos technology,” in ESSCIRC, 2012 Proceedings of the, September 2012, pp. 289-292.
[5]: U. Pfeiffer, Y. Zhao, J. Grzyb, R. Al Hadi, N. Sarmah, W. Forster, H. Rucker, and B. Heinemann, “A 0.53 thz reconfigurable source module with up to 1 mw radiated power far diffuse illumination in terahertz imaging applications,” Solid-State Circuits, IEEE Journal of, vol. 49, no. 12, pp. 2938-2950, December 2014.
[6]: Y. Tousi and E. Afshari, “14.6 a scalable thz 2d phased array with 17 dbm of eirp at 338 ghz in 65 nm bulk cmos,” in Solid-State Circuits Conference Digest of Technical Papers (ISSCC), 2014 IEEE International, February 2014, pp. 258-259.
[7]: E. Ojefors, J. Grzyb, Y. Zhao, B. Heinemann, B. Tillack, and U. Pfeiffer, “A 820ghz sige chipset for terahertz active imaging applications,” in Solid-State Circuits Conference Digest of Technical Papers (ISSCC), 2011 IEEE International, February 2011, pp. 224-226.

1. A method for generating and detecting centimeter, submillimeter or millimeter electromagnetic waves, comprising the use of a single electronic device as generation source and as detector of the waves emitted from the source.

2. A system for generating and detecting centimeter, submillimeter or millimeter electromagnetic waves, comprising an electronic device forming both a generation source and a detector of the waves emitted from the source.

3. The system as claimed in claim 2, comprising at least one adjustable-frequency AC power source equipped with an antenna.

4. The system as claimed in claim 3, comprising two adjustable-frequency AC power sources with current mirrors.

5. The system as claimed in claim 3, comprising a bias tee linked between the antenna and a low-impedance current amplifier that is itself linked to a voltage source, the output of the amplifier defining the detection output of the device.

6. The system as claimed in claim 3, comprising a bias tee linked between the antenna and a high-impedance current amplifier that is itself linked to a current source the output of the amplifier defining the detection output of the device.

7. The system as claimed in claim 3, comprising a grounded differential antenna linked to a low-impedance current amplifier that is itself linked to a voltage source, the output of the amplifier defining the detection output of the device.

8. The system as claimed in claim 3, comprising a grounded differential antenna linked to a high-impedance current amplifier that is itself linked to a current source, the output of the amplifier defining the detection output of the device.

9. The system as claimed in claim 2, comprising at least one frequency source equipped with an antenna.

10. The system as claimed in claim 9, comprising two frequency sources of “N-push” type that are equipped with a differential antenna.

11. The system as claimed in claim 2, comprising one or more frequency multiplication chains with a buffer circuit.

12. The system as claimed in one of claim 2, comprising one or more antennae with a beam that is able to be steered by an electrical control circuit.

13. The use of the method as claimed in claim 1 for imaging.

14. The use of the method as claimed in claim 1 for near-field imaging.

15. The use of the system as claimed in claim 2 for imaging.

16. The use of the system as claimed in claim 2 for near-field imaging.

17. The use of the method as claimed in claim 1 for generating and detecting terahertz electromagnetic waves.

18. The use of the system as claimed in claim 2 for generating and detecting terahertz electromagnetic waves.
